(19) United States
(12) Patent Application Publication
(10) Pub. No.: US 2009/0154970 A1
(43) Pub. Date: Jun. 18, 2009

(54) IMAGE FORMING APPARATUS AND IMAGE ERASING APPARATUS

(75) Inventors: Minoru Yoshida, Machida-shi (JP); Hiroshi Hashidume, Hino-shi (JP); Makoto Tani, Yokohama-shi (JP); Osamu Takagi, Chofu-shi (JP); Takahisa Hirano, Izunokuni-shi (JP); Jun Ishii, Tokyo (JP); Kazuhiro Ogura, Hiratsuka-shi (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/330,972

(22) Filed: Dec. 9, 2008

Related U.S. Application Data
(60) Provisional application No. 61/013,472, filed on Dec. 13, 2007.
(60) Provisional application No. 61/013,474, filed on Dec. 13, 2007.

(51) Int. Cl. G03G 15/20

(52) U.S. Cl. 399/341

(57) ABSTRACT

An image forming apparatus picks up each one of sheets stacked in a tray, allows a detecting sensor to detect whether a mark indicating a reusable sheet is assigned to the picked-up sheet, and cumulates the sheet in which the mark is not detected by the detecting sensor in a cumulative unit. The image forming apparatus erases a color of an image forming material by heating the sheet of which the mark is detected by the detecting sensor and receives the sheet of which the image forming material is erased in a sheet cassette. The image forming apparatus forms an image with the image forming material erasable by applying heat to the sheet received in the sheet cassette.

### CROSS-REFERENCE TO RELATED APPLICATION

This application claims the benefit of U.S. Provisional Applications No. 61/013,472, filed Dec. 13, 2007; and No. 61/013,474, filed Dec. 13, 2007.

### TECHNICAL FIELD

The present invention relates an image forming apparatus capable of forming an image with an erasable image forming material and an image erasing apparatus capable of erasing the image formed of the erasable image forming material.

### BACKGROUND

In the past, examples of a printing method used in printers include an electrophotographic type, an ink-jet type, a thermal recording type, and a thermal transfer type. In recent years, in order to reduce burdens on the environment and an amount of emission of carbon dioxide, there was suggested a method of reusing sheets used in printers. For example, JP-A-06-155906 discloses a method of recording images several times using sheets in which coloring and color-erasing are possible by heating. In addition, JP-A-11-268409 discloses a method of reusing sheets by erasing images printed on the sheets with color-erasable toner with heat. In addition, JP-A-10-88046 discloses a method of reusing sheets by erasing images printed on the sheets with color-erasable ink with heat.

On the other hand, in an actual use environment such as offices, in many cases, sheets on which conventional non-erasable images are printed (non-reusable sheets) and sheets on which erasable images are printed (reusable sheets) coexist. In this case, it is necessary to surely distinguish between the non-reusable sheets and the reusable sheets. For example, when the non-reusable sheets are erroneously processed as the reusable sheets, there is a high possibility that other images are printed on the non-reusable sheets with the images on the non-reusable sheets being not erased. Since the plurality of images are printed on the sheet in an overlapped manner in this case, the sheet cannot be used as a document. That is, in the actual use environment such as offices, a high possibility that the non-reusable sheets and the reusable sheets coexist has to be taken into consideration.

At present, a method of erasing an image on a sheet by heating is generally used as a sheet reusing method. In this method, an image erasing mechanism includes a heat roller and a thermal bar. In the image erasing mechanism, in order to immediately supply heat to be used to erase an image on the reusable sheet supplied by a user, residual heating is generally necessary. In this case, much energy is unnecessarily consumed. Moreover, since a thermal head scrapes the surface of a sheet, it is considered that considerable deterioration in an erase performance occurs due to attachment of toner or ink to the thermal head.

### SUMMARY

An object of the invention is to provide an image forming apparatus capable of preventing erroneous use of reusable sheets. Another object of the invention is to provide an image erasing apparatus capable of reducing deterioration in a performance with low power consumption.

According to an aspect of the invention, an image forming apparatus includes: a tray in which sheets are stacked; a detecting sensor which detects whether a mark indicating a reusable sheet is assigned to the sheets; a cumulative unit which cumulates the sheets of which the mark is not detected by the detecting sensor; a color erasing unit which erases a color of an image forming material attached onto the sheets of which the mark is detected by the detecting sensor; a sheet cassette which receives the sheets of which the image forming material is erased by the color erasing unit; and an image forming unit which forms an image by attaching the image forming material onto the sheets received in the sheet cassette.

According to another aspect of the invention, an image forming apparatus includes: a tray in which sheets are stacked; a detecting sensor which detects whether a mark indicating a reusable sheet is assigned to the sheets; a cumulative unit which cumulates the sheets of which the mark is not detected by the detecting sensor; a sheet cassette which receives the sheets of which the mark is detected by the detecting sensor; a color erasing unit which erases a color of an erasable image forming material attached onto the sheets taken out from the sheet cassette; and an image forming unit which forms an image by attaching the image forming material onto the sheets of which the image forming material is erased by the color erasing unit.

According to still another aspect of the invention, an image erasing apparatus includes: a heat source which heats a sheet on which an image is formed with an image forming material erasable by heating; a belt which applies heat supplied from the heat source to the sheet being brought into contact with the belt while being transported; and a sheet cassette which receives the sheet to which the heat supplied from the heat source is applied through the belt.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawing, which are incorporated in and constitute a part of the specification, illustrate embodiments of the invention, and together with the general description given above and the detailed description of the embodiments given below, serve to explain the principles of the invention.

FIG. 1 is a diagram illustrating a first configuration example of an image forming apparatus.

FIG. 2 is a diagram illustrating the first configuration example of the image forming apparatus.

FIG. 3 is a flowchart explaining an operation example of a reuse processing unit.

FIG. 4 is a diagram illustrating a second configuration example of the image forming apparatus.

FIG. 5 is a diagram illustrating the second configuration example of the image forming apparatus.

FIG. 6 is a diagram illustrating a third configuration example of the image forming apparatus.

FIG. 7 is a diagram illustrating the third configuration example of the image forming apparatus.

FIG. 8 is a diagram illustrating a fourth configuration example of the image forming apparatus.

FIG. 9 is a diagram illustrating the fourth configuration example of the image forming apparatus.

FIG. 10 is a flowchart for explaining an operation example of a printer of the image forming apparatus having the fourth configuration example.

FIG. 11 is a flowchart for explaining an operation example of the reuse processing unit of the image forming apparatus having the fourth configuration example.

FIG. 12 is a diagram illustrating a configuration example of an image forming apparatus capable of printing a mark with special ink.

FIG. 13 is a diagram illustrating a first configuration example of an erasing mechanism.

FIG. 14 is a diagram illustrating a configuration example of a belt used in the erasing mechanism shown in FIG. 13.

FIG. 15 is a diagram illustrating a second configuration example of the erasing mechanism.

FIG. 16 is a diagram illustrating a configuration example of a belt used in the erasing mechanism shown in FIG. 15.

### DETAILED DESCRIPTION

Hereinafter, an embodiment of the invention will be described in detail with reference to the accompanying diagrams.

First, a first configuration example of an image forming apparatus will be described according to the embodiment.

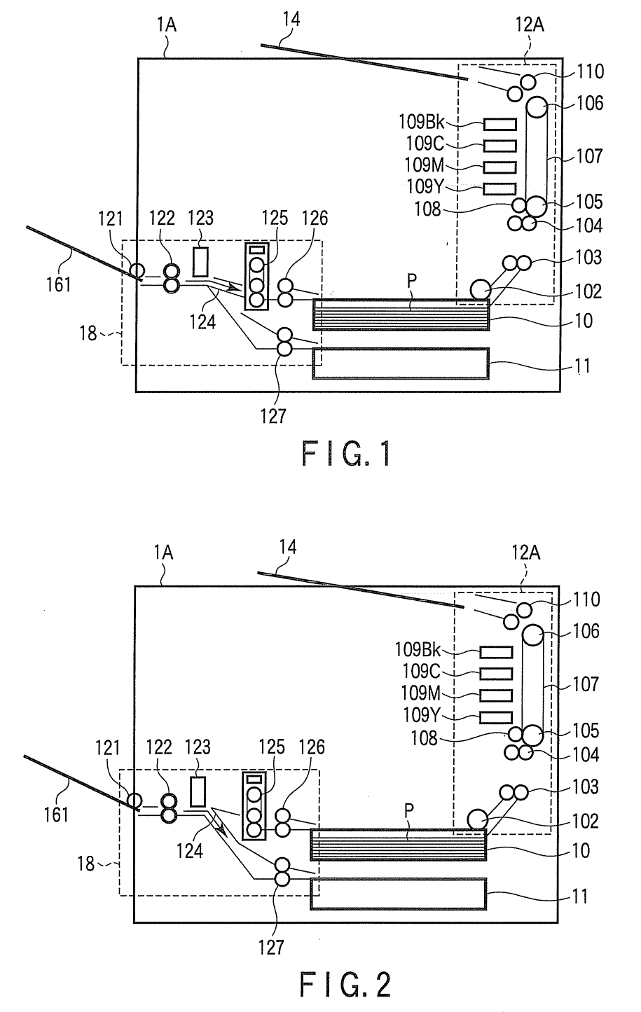

FIGS. 1 and 2 are diagrams illustrating the first configuration example of an image forming apparatus 1A. The image forming apparatus 1A shown in FIGS. 1 and 2 includes a sheet cassette 10, a cumulative unit 11, a printer 12A, a sheet discharging tray 14, a sheet feeding tray 16, and a reuse processing unit 18.

The sheet cassette 10 is a cassette which receives sheets. The sheet cassette 10 stores printing sheets P on which an image is printed by the printer 12A. The cumulative unit 11 cumulates sheets which are not reused. The printer 12A forms an image on each sheet P. In the first configuration example shown in FIGS. 1 and 2, the printer 12A is an ink-jet type printer. The printer 12A is a color printer. The sheet discharging tray 14 holds the sheets printed by the printer 12A.

The sheet feeding tray 16 is a sheet holding unit which holds sheets which are a target processed by the reuse processing unit 18. Reusable sheets and non-reusable sheets may be stacked together in the sheet feeding tray 16. In this case, a user may stack printed sheets in the sheet feeding tray 16 without considering whether the printed sheets are the reusable sheets or the non-reusable sheets. The reuse processing unit 18 distinguishes between the reusable sheets and the non-reusable sheets. The reuse processing unit 18 also functions as erasing an image printed on the reusable sheets. In this case, the reuse processing unit 18 functions as an image erasing apparatus.

Next, the configuration of the printer 12A will be described in detail.

As shown in FIGS. 1 and 2, the printer 12A includes a sheet feeding roller 102, a pair of transport rollers 103, a pair of resist rollers 104, a driven roller 105, a driving roller 106, a transport belt 107, a pressing roller 108, a group of ink-jet heads 109 (109Y, 109M, 109C, and 109Bk), and a pair of transport rollers 110.

The sheet feeding roller 102 takes out each one of the sheets P stacked in the sheet cassette 10. The sheet feeding roller 102 feeds the sheet P taken out from the sheet cassette 10 to the pair of transport rollers 103 and the pair of resist rollers 104. The pair of resist rollers 104 transports the sheet P to the transport belt 107 at predetermined timing. A tension force exerted by the driving roller 106 and the driven roller 105 is applied to the transport belt 107. The transport belt 107 is driven with rotation of the driving roller 106. The pressing roller 108 presses the sheet P against the transport belt 107.

In the transport belt 107, holes are formed at a predetermined interval on the surface thereof. A negative pressure chamber (not shown) connected to a fan (not shown) adsorbing the sheet P to the transport belt 107 is provided inside the transport belt 107. The sheet P is transported while being adsorbed to the transport belt 107.

The group of ink-jet heads 109 includes an ink-jet head 109Y, an ink-jet head 109M, an ink-jet head 109C, and an ink-jet head 109Bk. The ink-jet heads 109Y, 109M, 109C, and 109Bk are sequentially arranged along the transport belt 107. For example, in the example illustrating in FIGS. 1 and 2, the ink-jet heads 109Y, 109M, 109C, and 109Bk are sequentially arranged from an upstream side in a transport direction of the sheet P transported by the transport belt 107.

The ink-jet head 109Y is an ink-jet head which ejects erasable yellow (Y) ink. The ink-jet head 109M is an ink-jet head which ejects erasable magenta (M) ink. The ink-jet head 109C is an ink-jet head which ejects erasable cyan (C) ink. The ink-jet head 109Bk is an ink-jet head which ejects erasable black (Bk) ink.

The ink-jet heads 109Y, 109M, 109C, and 109Bk form images of respective colors on the sheet. The ink-jet heads 109Y, 109M, and 109C eject ink corresponding to a yellow component, a magenta component, and a cyan component for the respective color images, respectively. The group of ink-jet heads 109 forms a color image on the sheet by repeatedly printing the respective color images on the sheet.

The pair of transport rollers 110 discharges the sheet on which the image is printed by the group of ink-jet heads 109 to the sheet discharging tray 14.

The printer 12A uses the above-described erasable ink to print the image on the sheet and also print information indicating a reusable sheet. The information indicating the reusable sheet is information which is detected by a detecting sensor 123 described below. For example, the information indicating the reusable sheet is a mark printed on the sheet under a specific condition. In this case, the printer 12A prints the mark on the sheet whenever the printer 12A prints an image on the sheet. Alternatively, this mark may be assigned in advance to the sheet. In this case, the printer 12A may not print the mark.

Next, an image forming material used in the printer 12A will be described.

The printer 12A uses ink (color-erasable ink) which is the image forming material capable of being erased by heating with a predetermined temperature. The ink used in the printer 12A is not limited to a specific material, but may be ink which is capable of being erased by the heating with the predetermined temperature. In addition, the image forming material capable of being used in the ink in the printer 12A is disclosed in JP-A-2007-212613, JP-A-2007-90704, and Japanese Patent No. 3711017, for example.

For example, a basic component of the image forming material such as color-erasable ink or color-erasable toner is formed of a coloring compound, developer, binder resin, etc. Since in this image forming material, a coloring compound is in a colored state under an influence of the developer, a user is able to recognize colors. In addition, upon applying heat to the image forming material being in the colored state, the binder resin is softened. The developer is mainly easy to move to the surface of the binder resin from inside thereof and easy to move and diffuse to a sheet. For that reason, since the coloring compound is not under the influence of the developer, the coloring compound is subjected to color erasing. Accordingly, colors cannot be recognized as the image forming material.

The coloring compound is a precursor compound of pigments which form coloring images such as characters or figures. It is preferable that the coloring compound is formed of an electron-supplying organic matter such as leuco-auramines, diaryl phthalides, polyaryl carbinols, acyl auramines, aryl auramines, Rhodamine B lactams, indolines, spiropyrans, or fluorans.

The developer is a compound which allows the coloring compound to exhibits colors by reciprocal interaction (supply and reception of electrons or protons mainly) with the coloring compound. It is preferable that the developer is formed of phenols, phenol metallic salts, carboxylic acid metallic salts, benzophenones, sulfone acid, salt of sulfonic acid, phosphoric acids, phosphoric acid metallic salts, acid phosphate ester, acid phosphate ester metallic salts, phosphorous acids, phosphorous acid metallic salts, etc.

The binder resin serves as diffusing the coloring compound and the developer to exhibit colors. On the other hand, the binder resin is compatible with the coloring compound in heating and does not have affinity with the developer.

A printer forming an image with ink as the image forming material capable of being erased (color-erased) by heating has to be designed so that a temperature equal to or higher than an erasing temperature is not applied to the ink in printing. When a temperature within the printer is raised equal to or higher than the erasing temperature, the color of ink may be erased before the ink is printed to the sheet. In this case, of course, a normal image is not formed on the sheet. Moreover, it is preferable that the erasing temperature of the ink is set as low as possible in consideration of power consumption of the printer. Accordingly, the printer needs to be designed so that the temperature applied to the ink is not high as much as possible.

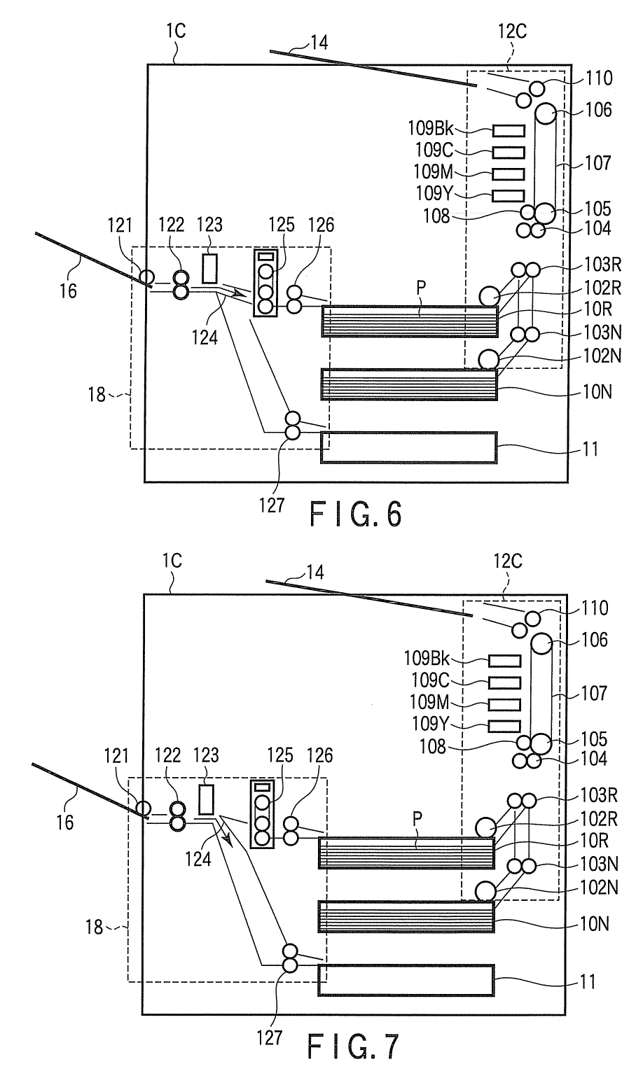

In consideration of the above description, an ink-jet type printer needs to be designed so that the temperature equal to or higher than the erasing temperature is not applied to the ink therein. For example, it is preferable that the ink-jet type printer uses a piezo-type printing head as an ink-jet head. Moreover, a heat dissipation plate (not shown) may be provided in the vicinity of the head. It is assumed that the ink-jet type printer shown in FIGS. 1 and 2 (or FIGS. 6, 7, 8, 9, and 12) uses the piezo-type printing head equipped with the heat dissipation plate. For example, when the erasing temperature of ink is designed to be 70°, the ink-jet type printer is designed so that the temperature of ink in the head is surely not 60° or more. This design can be easily achieved by providing the heat dissipation plate or the like in the piezo-type printing head.

Next, the reuse processing unit 18 will be described.

The reuse processing unit 18 distinguishes the sheets stacked in the sheet feeding tray 16 as the reusable sheets or the non-reusable sheets. The reuse processing unit 18 functions as erasing an image printed on the reusable sheets as well. That is, the reuse processing unit 18 makes the sheets, on which an erasable image is printed (the reusable sheets), reusable. The user stacks sheets (at this time, the reusable sheets and the non-reusable sheets may coexist) in the sheet feeding tray 16 to be subjected to reuse-processing by the reuse processing unit 18. A sensor (not shown) detecting the sheets stacked in the sheet feeding tray 16 detects whether the sheets are placed in the sheet feeding tray 16.

In this embodiment, as a sheet holding unit which holds the sheets as a target of the reuse processing, the sheet feeding tray 16 which stacks the sheets will be described. However, as the sheet holding unit which holds the sheets, the invention is not limited to the sheet feeding tray 16 in which the sheets are stacked. For example, as the sheet holding unit, a unit capable of receiving a plurality of sheets to be erected vertically may be used.

The reuse processing unit 18 includes a pickup roller 121, a pair of transport rollers 122, the detecting sensor 123, a transport passage switching mechanism 124, an erasing mechanism 125, a sheet setting mechanism 126, and a sheet cumulating mechanism 127.

The pickup roller 121 picks up each one of the sheets stacked in the sheet feeding tray 16 to insert the sheet into the reuse processing unit 18. For example, when the sensor of the sheet feeding tray 16 detects the sheet, the pickup roller 121 picks up each one of the sheets stacked in the sheet feeding tray 16. The pickup roller 121 inserts the picked-up sheet into the reuse processing unit 18. The pair of transport rollers 122 transports each of the sheets supplied by the pickup roller 121 to the detecting sensor 123.

The detecting sensor 123 determines whether the sheet is the reusable (image erasable) sheet or the non-reusable (image non-erasable) sheet. The detecting sensor 123 detects information indicating whether the sheet is reusable or not. For example, the detecting sensor 123 detects whether a predetermined mark is present at a predetermined location of the sheet. In this case, the detecting sensor 123 includes a scanner which reads an image of the predetermined location and a detector which detects the predetermined mark from the image read by the scanner. Reuse determination of the sheets in accordance with the result detected by the detecting sensor 123 will be described in detail below.

The transport passage switching mechanism 124 switches a transport passage used to transport the sheets in accordance with the result detected by the detecting sensor 123. For example, when the detecting sensor 123 determines that the sheet is reusable, the transport passage switching mechanism 124 switches the transport passage to transport the sheet to the erasing mechanism 125, as indicated by an arrow in FIG. 1.

Alternatively, when the detecting sensor 123 determines that the sheet is not reusable, the transport passage switching mechanism 124 switches the transport passage to transport the sheet to the cumulative unit 11, as indicated an arrow in FIG. 2. In this case, the cumulative unit 11 cumulates sheets which are not reusable and are to be disposed as wastes.

Moreover, the cumulative unit 11 may be equipped with a shredder which shreds the sheets. In this case, the cumulative unit 11 is configured to allow the shredder to shred the transported sheets and collect shredded paper pieces.

The erasing mechanism 125 erases the image formed on the sheet. For example, the erasing mechanism 125 heats the sheet up to the erasing temperature of the ink as the image forming material. In the sheet heated up to the erasing temperature by the erasing mechanism 125, the image is erased. The sheet setting mechanism 126 transports and stores the sheet of which the image is erased by the erasing mechanism 125 to the sheet cassette 10. Here, the sheet cassette 10 is a cassette which receives the sheets to be printed by the printer 12A. That is, the image forming apparatus 1A is capable of reusing the sheets subjected to image reuse processing by the reuse processing unit 18 as printing sheets.

Next, operations of the reuse processing unit 18 having the above-described configuration will be described.

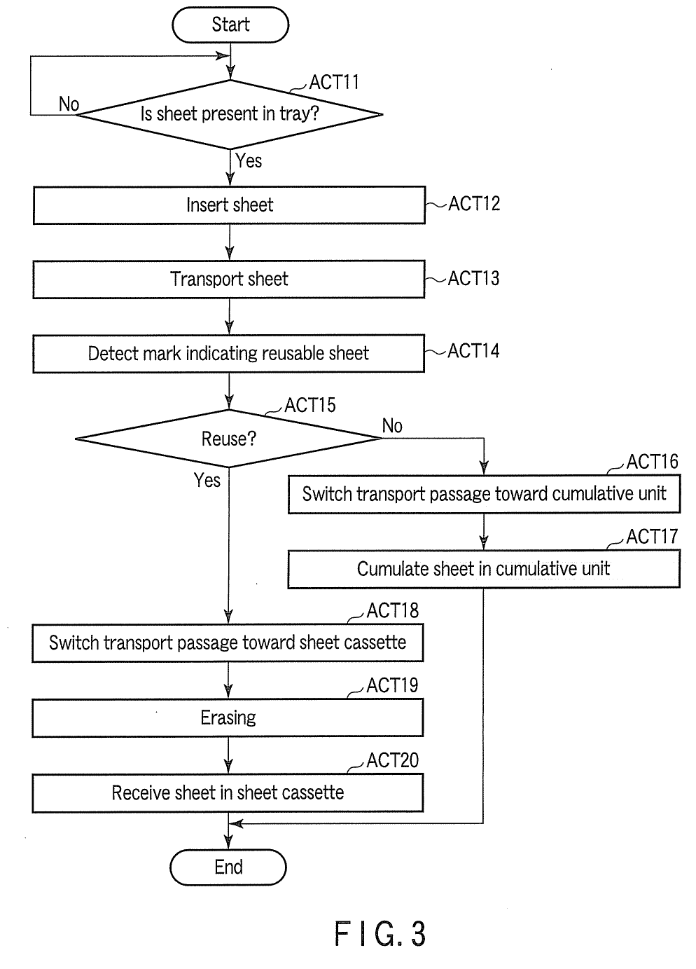

FIG. 3 is a flowchart explaining an operation example of the reuse processing unit 18. In addition, the operations of the reuse processing unit 18 described below are controlled mainly by a controller (not shown).

When the sensor (not shown) which is provided in the sheet feeding tray 16 to detect the sheet detects the sheet (Yes in ACT 11), the pickup roller 121 inserts each one of the sheets stacked in the sheet feeding tray 16 into the reuse processing unit 18 (ACT 12). The pair of transport rollers 122 transports the sheet inserted by the pickup roller 121 to the detecting sensor 123 (ACT 13). The detecting sensor 123 detects the information indicating whether the sheet is reusable from the sheet transported by the pair of transport rollers 122 (ACT 14). For example, the detecting sensor 123 detects whether the predetermined mark is present at the predetermined location of the sheet. The reuse determination of the sheet in accordance with the result detected by the detecting sensor 123 will be described in detail below.

When the sheet is determined not to be reusable in accordance with the reuse determination which is based on the result detected by the detecting sensor 123 (No in ACT 15), the transport passage switching mechanism 124 switches the transport passage to transport the sheet to the cumulative unit 11 (ACT 16), as shown in FIG. 2. The sheet transported in this manner is cumulated in the cumulative unit 11 (ACT 17).

Alternatively, when the sheet is determined to be reusable in accordance with the reuse determination which is based on the result detected by the detecting sensor 123 (Yes in ACT 15), the transport passage switching mechanism 124 switches the transport passage to transport the sheet to the erasing mechanism 125 and the sheet cassette 10 (ACT 18), as shown in FIG. 1. The sheet transported in this manner is transported to the erasing mechanism 125. The erasing mechanism 125 erases the image formed on the transported sheet (ACT 19). The erasing mechanism 125 heats the sheet so that the surface of the sheet reaches the temperature equal to or higher than the erasing temperature in order to erase the color of the image on the surface of the sheet. The sheet setting mechanism 126 stores the sheets subjected to the erasing by the erasing mechanism 125 in the sheet cassette 10 (ACT 20).

During the series of processing described above, each of the reusable sheets stacked in the sheet feeding tray is subjected to the erasing and received in the sheet cassette and each of the non-reusable sheets stacked in the sheet feeding tray is cumulated in the cumulative unit 11.

As described above, the image forming apparatus determines whether to reuse each one of the sheets stacked in the sheet feeding tray. The image forming apparatus receives the sheets detected to be reusable as the printing sheets. The image forming apparatus receives the sheets detected not to be reusable as wasting sheets. That is, even when the user stacks the reusable sheets and the non-reusable sheets in the sheet feeding tray together, the image forming apparatus is capable of distinguishing the reusable sheets from the non-reusable sheets. Accordingly, even when the reusable sheets and the non-reusable sheets coexist, the reusable sheets and the non-reusable sheets can be processed in the distinguishing manner. For example, even when the user erroneously places the sheet on which a non-erasable image is printed (the non-reusable sheet) in the sheet feeding tray, it is possible to surely cumulate the non-reusable sheet as the wasting sheet in the cumulative unit.

Next, an image forming apparatus having a second configuration example will be described.

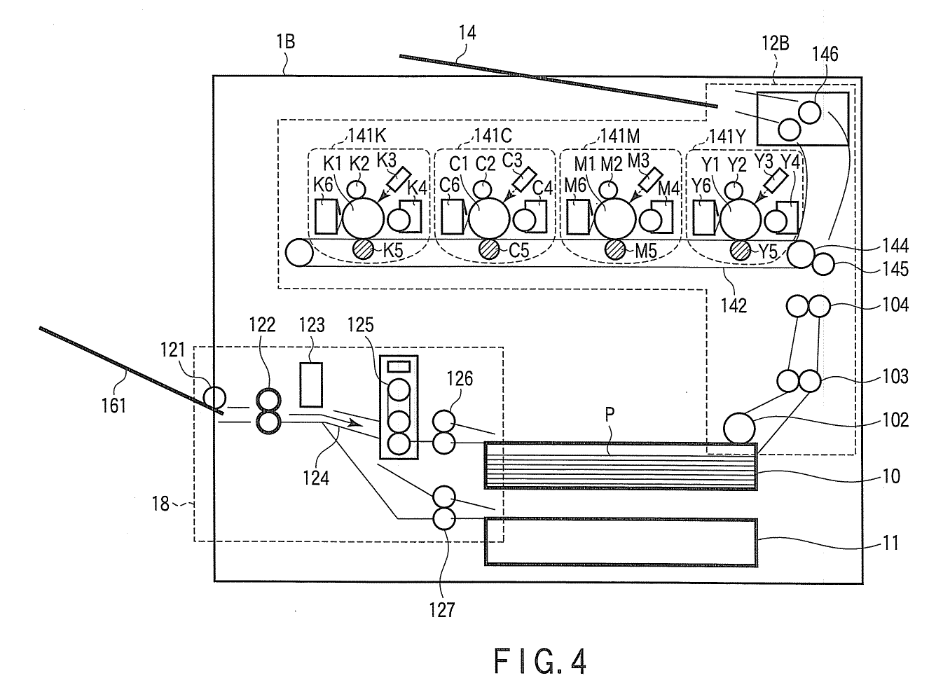

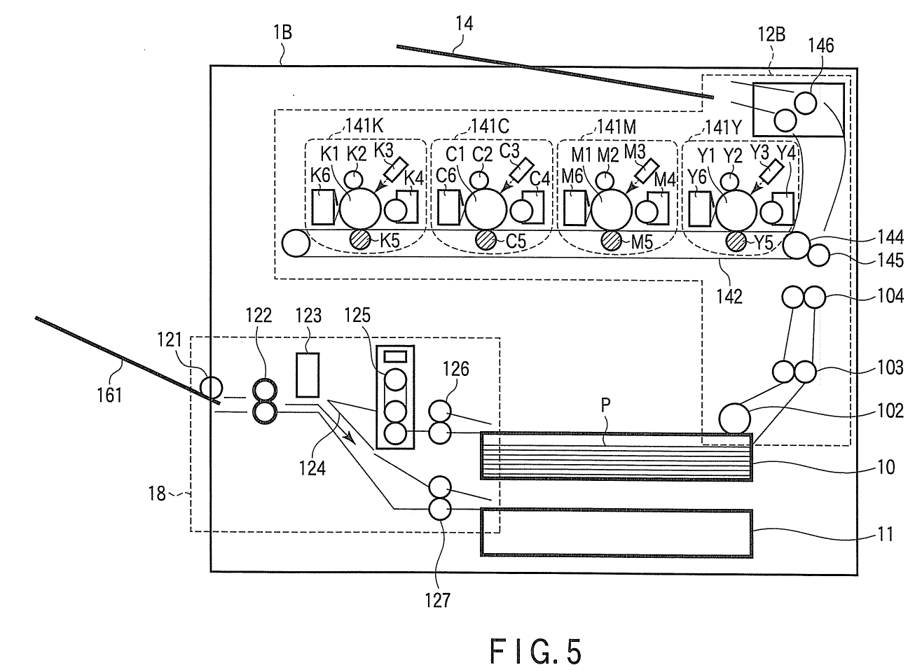

FIGS. 4 and 5 are diagrams illustrating the second configuration example of the image forming apparatus. An image forming apparatus 1B shown in FIGS. 4 and 5 is different from the image forming apparatus 1A having the first configuration example shown in FIGS. 1 and 2 in that the configuration (image forming method) of a printer 12B is different from the configuration of the printer 12A. That is, the printer 12A of the image forming apparatus 1A having the first configuration example shown in FIGS. 1 and 2 is the ink-jet type printer. However, the printer 12B of the image forming apparatus 1B having the second configuration example shown in FIGS. 4 and 5 is an electrophotographic type printer.

Moreover, in the image forming apparatus 1B having the second configuration example, the configurations other than the configuration of the printer 12B may be the same as those in the image forming apparatus 1A having the first configuration example. For example, the configuration and the operation of a reuse processing unit 18 of the image forming apparatus 1B are the same as those of the reuse processing unit 18 of the image forming apparatus 1A. Accordingly, the configuration and the operation of the reuse processing unit 18 of the image forming apparatus 1B are not described in detail. The image forming apparatus 1B will be described along with the configuration and the operation of the printer 12B.

Next, the printer 12B will be described in detail.

As described above, the printer 12B is the electrophotographic type printer. Moreover, the printer 12B is also a color printer. The printer 12B includes a sheet feeding roller 102, a pair of transport rollers 103, a pair of resist rollers 104, a plurality of image forming units 141 (141K, 141C, 141M, and 141Y), an intermediate transfer belt 142, a driving roller 143, a supporting roller 144, a secondary transfer roller 145, and a fixing unit 146. The image forming unit 141Y (141K, 141C, and 141M) includes an image supporting member Y1 (K1, C1, and M1), a charging roller Y2 (K2, C2, and M2), an exposure member Y3 (K3, C3, and M3), and a development member Y4, (K4, C4, and M4), a transfer roller Y5 (K5, C5, and M5), and a cleaner Y6 (K6, C6, and M6).

The sheet feeding roller 102 takes out each one of the sheets P stacked in a sheet cassette 10. The sheet feeding roller 102 transports the sheet P taken out from the sheet cassette 10 to the pair of transport rollers 103 and the pair of resist rollers 104. The pair of resist rollers 104 transports the sheet P at predetermined timing.

The plurality of image forming units (141K, 141C, 141M, and 141Y) are respectively arranged opposite the intermediate transfer belt 142 serving as an intermediate transfer member as a transfer-receiving member. The intermediate transfer belt 142 as the transfer-receiving member is held with appropriate tension by the driving roller 143 and the supporting roller 144. The intermediate transfer belt 142 is driven with the rotation of the driving roller 143. Each of the image forming units (141K, 141C, 141M, and 141Y) forms a toner image on the intermediate transfer belt 142 with erasable toner of each color.

First, in the image forming unit 141Y in a first step, the image supporting member Y1 is a photoconductive drum which includes a photoconductive layer such as an organic system or an amorphous silicon system provided on a conductive base substrate. For example, the photoconductive drum as the image supporting member is an organic photoconductive member which charges a negative polarity. The charging roller Y2 uniformly charges the image supporting member Y1. For example, the charging roller Y2 uniformly charges the surface of the photoconductive drum as the image supporting member Y1 with −500 v. The exposure member Y3 exposes the image supporting member Y1 charged by the charging roller Y2 using an image-modulated laser beam, an LED or the like. An electrostatic latent image is formed on the surface of the photoconductive drum as the image supporting member Y1 exposed by the exposure member Y3. At this time, the surface potential of the photoconductive drum as the exposed image supporting member Y1 is about −80 v, for example.

The development member Y4 changes the electrostatic latent image formed on the surface of the photoconductive drum as the image supporting member Y1 into a visible image. The development member Y4 develops the electrostatic latent image using a two-component development method in which nonmagnetic toner charged with a negative polarity and magnetic carriers are mixed together. That is, the development member Y4 forms carrier heads on the development roller equipped with a magnet and applies a potential of −200 to −400 v to the development roller. Accordingly, on the surface of the photoconductive drum as the image supporting member Y1, the toner is not attached to a non-exposure member, but is attached to the exposure member. The toner within the development member Y4 is erasable yellow toner. Accordingly, the image forming unit 141Y forms a toner image on the surface of the photoconductive drum as the image supporting member Y1 with the erasable yellow toner supplied by the development member Y4.

Moreover, the development method is not limited to the two-component development method, but a contact one-component development method, a non-contact one-component development method, a conductive one-component development method, or the like may be used. The toner image formed on the surface of the photoconductive drum as the image supporting member Y1 is transferred to the intermediate transfer belt 142 as the transfer-receiving member. The transfer roller Y5 as the transfer member comes in contact with the rear surface of the intermediate transfer belt 142, when viewed from the image supporting member Y1. The transfer roller Y5 supplies an electric field to be used to transfer the toner image from the rear surface of the intermediate transfer belt 142. Voltage applied to the transfer member is in the range of about 300 to 2 kv. The cleaner Y6 removes the toner or the like remaining on the surface of the photoconductive drum as the image supporting member Y1 after the transferring. The cleaner Y6 is provided in the front of the charging roller Y2 in a rotational direction of the photoconductive drum as the image supporting member Y1. The toner removed from the image supporting member Y1 by the cleaner Y6 is collected in a void toner box (not shown).

The image forming units 141M, 141C, and 141K have the same configuration as that of the image forming unit 141Y described above. That is, the image supporting member M1 (C1 and K1), the charging roller M2 (C2 and K2), the exposure member M3 (C3 and K3), the development member M4 (C4 and K4), and the transfer roller M5 (C5 and K5) have the same configuration as those of the image supporting member Y1, the charging roller Y2, the exposure member Y3, the development member Y4, and the transfer roller Y5, respectively.

The image forming units repeatedly transfer (primary-transfers) the toner image developed with the erasable toner of respective colors on the intermediate transfer belt 142. As a result, a color image in which the erasable toner image of each color is overlapped with each other is formed on the intermediate transfer belt 142. The color image formed of the toner of plural colors transferred on the intermediate transfer belt 142 as the transfer-receiving member is secondary-transferred on the sheet P at a predetermined secondary transfer location. The support roller 144 and the secondary transfer roller 145 are provided at the secondary transfer location where the toner images on the intermediate transfer belt 142 are transferred on the sheet. In this case, the pair of resist rollers 104 transports the sheet P to the secondary transfer location at timing at which the toner images on the intermediate transfer belt 142 arrive. The toner images on the intermediate transfer belt 142 are transferred to the sheet at the secondary transfer location.

When the support roller 144 is grounded, a positive (+) polarity bias is applied to the secondary transfer roller 145 in order to transfer toner to the sheet P as a second transfer-receiving member. As for a transfer bias, a value adjusted in accordance with resistance or environment of the secondary transfer roller 145 and resistance of the sheet as the second transfer-receiving member is selected. For example, the transfer bias is selected from a value in the range of +300 to 5 kv. In addition, by grounding the secondary transfer roller 145, a bias of a negative polarity may be applied to the support roller 144. The sheet P to which the toner images are transferred at the secondary transfer location is discharged to the sheet discharging tray 14 through the fixing unit 146. The fixing unit 146 fixes the toner images transferred to the sheet P to the sheet P.

As described above, the toner images fixed to the sheet by the fixing unit 146 is formed by the erasable toner of each color. Accordingly, the colors of the toner images as the color image fixed to the sheet are erasable. For example, the toner images on the sheet are erased when the toner images are heated with a temperature equal to or higher than a predetermined color-erasable temperature (at least a temperature equal to or higher than a fixing temperature).

The transfer rollers Y5, M5, CS, and K5 are formed of, for example, a urethane sponge of which resistance is adjusted. For example, the transfer rollers Y5, M5, CS, and K5 may be formed of a Φ 14 mm roller in which a sponge having a 106 Ω·cm resistant value is formed in an Φ 8 mm shaft. As the transfer roller which is the primary transfer member, a member having certain resistance, such as a transfer brush or a transfer blade, may be provided. In the intermediate transfer belt 142, resistance thereof is adjusted by dispersing carbon in polyimide resin having a 100 μm thickness, for example. The charging rollers Y2, M2, C2, and K2 are formed by forming urethane rubber around a metal shaft (Φ 8 mm) and coating nylon resin having a good detachable property on the surface, for example. In this case, the charging rollers Y2, M2, C2, and K2 may be configured so that a urethane rubber layer (t=3 mm) has a resistant value of 2×107 Ω·cm and the surface layer (t=0.05 mm) has a resistant value of 5×108 Ω·cm.

In the electrophotographic type printer described above, it is assumed that the toner as the image forming material erasable (color-erasable) by heat is used. In this case, it is required that the temperature equal to or higher than the erasing temperature is not applied to the toner in printing. That is because when the image forming material is heated with the temperature equal to or higher than the erasing temperature before the image forming material is printed on the sheet, the image forming material may be erased. In this case, it is preferable that the erasing temperature of the toner is set to be as low as possible in consideration of the power consumption of the printer. Accordingly, the temperature applied to the toner is set to be not high as much as possible within the printer.

That is, the electrophotographic type printer described above is designed so that the temperature applied to the toner during the printing does not reach or exceed the erasing temperature. For example, in the electrophotographic type printer shown in FIGS. 4 or 5, the erasing temperature of the toner is set to be higher than the fixing temperature in fixing (which is a process in which a temperature given to the toner in the printing is the highest). For example, on the assumption that the fixing temperature is 120°, the erasing temperature of the toner used in the electrophotographic type printer is set to 140°.

Moreover, the printer 12B using the erasable toner described above prints an image on the sheet and also prints information indicating the reusable sheet. The information indicating the reusable sheet is information detected by the detecting sensor 123 which will be described below. For example, the information indicating the reusable sheet is a mark which is printed on the sheet under a specific condition. In this case, the printer 12B prints the mark, whenever the printer 12B prints the image on every sheet. This mark may be printed in advance on the sheet. At this time, the printer 12B may not print the mark.

Next, an image forming apparatus having a third configuration example will be described.

FIGS. 6 and 7 are diagrams illustrating the third configuration example of the image forming apparatus. An image forming apparatus 1C shown in FIGS. 6 and 7 is provided with a reuse sheet cassette receiving reusable sheets and a new sheet cassette receiving new sheets which are a cassette receiving sheets. The image forming apparatus 1C having the third configuration example shown in FIGS. 6 and 7 includes a reusable sheet cassette 10R and a new sheet cassette 10N in place of the sheet cassette 10 of the image forming apparatus 1A having the first configuration example shown in FIGS. 1 and 2. A printer 12C of the image forming apparatus 1C is capable of carrying out the same functions even when the printer 12C is replaced with the electrophotographic type printer 12B shown in FIGS. 4 and 5.

As shown in FIGS. 6 or 7, in the image forming apparatus 1C including the reusable sheet cassette 10R and the new sheet cassette 10N as the cassette receiving print sheets, a user is able to select sheets on which an image is formed, between the reusable sheets and the new sheets through an operation panel (not shown). For example, in the image forming apparatus 1C, the user is able to select the reusable sheets upon printing to correct a document which is being prepared and selects the new sheets upon printing important data. That is, in the image forming apparatus 1C, the print sheets are selected in accordance with a request of the user.

The printer 12C takes out each one of the sheets from the cassette in which the sheets selected by the user for the printing are received (or the cassette selected by the user in person). For example, when the user selects the reusable sheets, the printer 12C allows a pickup roller 102R to pick up each of the sheets P from the reusable sheet cassette 10R. Each of the sheets P picked up by the pickup roller 102R is transported to a pair of resist rollers 104 by a pair of transport rollers 103R or the like. When each of the sheets P is transported to the pair of resist rollers 104, the printer 12C prints an image on the sheet P and then discharges the sheet P to a sheet discharging tray 14, as in the printer 12A of the image forming apparatus 1A.

When the user selects the new sheets, the printer 12C allows a pickup roller 102N to pick up each one of new sheets P′ from the new sheet cassette 10N. Each one of the sheets P′ picked up by the pickup roller 102N is transported to the pair of resist rollers 104 by a pair of transport rollers 103N, the pair of transport rollers 103R, and the like. When each of the sheets P′ is transported to the pair of resist rollers 104, the printer 12C prints an image on the sheet P′ and then discharges the sheet P′ to the sheet discharging tray 14, as in the printer 12A of the image forming apparatus 1A.

Moreover, the printer 12C using the erasable ink described above prints the image on the reusable sheet P or the new sheet P′ and also prints the information (mark) indicating the reusable sheet, as in the printer 12A of the image forming apparatus 1A.

The configuration and operation of a reuse processing unit 18 of the image forming apparatus 1C are the same as those of the reuse processing unit 18 of the image forming apparatus 1A. However, in the reuse processing unit 18 of the image forming apparatus 1C, a cassette receiving the sheets subjected to erasing by the erasing mechanism 125 is the reusable sheet cassette 10R. Accordingly, detailed description of the configuration and operation of the reuse processing unit 18 of the image forming apparatus 1C is omitted. The method of selecting the new sheets or the reusable sheets (or selecting the cassette) is not limited to the method of directly selecting the sheets through the operation panel (not shown). For example, the new sheets or the reusable sheets (the cassette) may be selected by an external apparatus such as a PC on which a printer driver requesting the image forming apparatus to print the image is executed.

Next, an image forming apparatus having a fourth configuration example will be described.

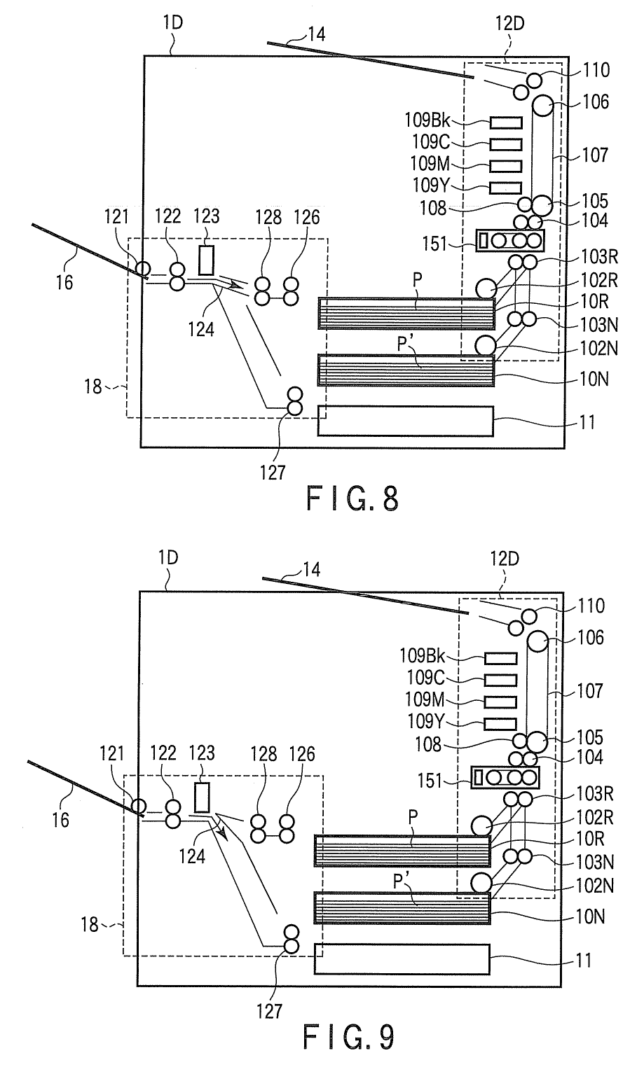

FIGS. 8 and 9 are diagrams illustrating the fourth configuration example of the image forming apparatus. In an image forming apparatus 1D having the fourth configuration example shown in FIGS. 8 and 9, an erasing mechanism 151 erasing an image on a sheet is provided within a printer 12D. The image forming apparatus 1D shown in FIGS. 8 and 9 is equipped with a reusable sheet cassette 10R receiving the reusable sheets and a new sheet cassette 10N receiving new sheets, as in the image forming apparatus 1C having the third configuration example.

The image forming apparatus 1D shown in FIGS. 8 and 9 has the same configuration as that of the image forming apparatus 1C having the third configuration example, except that the erasing mechanism 151 is not provided within a reuse processing unit 18B but provided within the printer 12D. In the image forming apparatus 1D shown in FIGS. 8 and 9, sheets which are not subjected to the erasing of an image are received in the reusable sheet cassette 10R. That is, an image on the sheet is not erased in the reuse processing unit 18B of the image forming apparatus 1D and the reusable sheets and the non-reusable sheets are distinguished to be transported to the reusable sheet cassette 10R or the cumulative unit 11. The printer 12D of the image forming apparatus 1D is capable of carrying out the same functions even when the printer 12D is replaced with the electrophotographic type printer 12B, which is shown in FIGS. 4 and 5, including the erasing mechanism 151.

Next, the printer 12D of the image forming apparatus 1D will be described.

In the image forming apparatus 1D shown in FIGS. 8 and 9, the user selects print sheets between the reusable sheets and new sheets, as in the image forming apparatus 1C having the third configuration example.

When the user selects the new sheets as the print sheets, the pickup roller 102N picks up the sheet P′ from the new sheet cassette 10N. The pair of transport rollers 103N and the pair of transport rollers 103R transport the sheet P′ picked up by the pickup roller 102N to the pair of resist rollers 104 through the erasing mechanism 151. In this case, since this sheet is the new sheet, the erasing of an image is not necessary. Accordingly, the erasing mechanism 151 passes the sheet P′ being in a standby state. The pair of resist rollers 104 transports the sheet P′ to the transport belt 107 at predetermined timing. The printer 12D prints an image on the sheet P′ transported through the transport belt 107 and discharges the sheet P′ to the sheet discharging tray 14, as in the printer 12A.

Alternatively, when the user selects the reusable sheet as the print sheet (or does not select the new sheet), the pickup roller 102R picks up the sheet P from the reusable sheet cassette 10R. The pair of transport rollers 103R transports the sheet P picked up by the pickup roller 102R to the erasing mechanism 151. In this case, the reusable sheet P is not subjected to the erasing of an image. Accordingly, the erasing mechanism 151 operates in order to erase the image on this sheet.

That is, the erasing mechanism 151 heats a heat member heating the sheet up to the temperature equal to or higher than a predetermined erasing temperature so that the color of the image is erased. At this time, the erasing mechanism 151 heats the sheet P being transported with the temperature equal to or higher than the predetermined erasing temperature. The image on the sheet P which is heated with the temperature equal to or higher than the predetermined erasing temperature is erased. The sheet P of which the image is erased by the erasing mechanism 151 is transported to the pair of resist rollers 104. The pair of resist rollers 104 transports the sheet P subjected to the erasing to the transport belt 107 at predetermined timing. The printer 12D prints an image on the sheet P subjected to the erasing and discharges the sheet P to the sheet discharging tray 14, as in the printer 12A.

Next, operations of the printer 12D having the above-described configuration will be described.

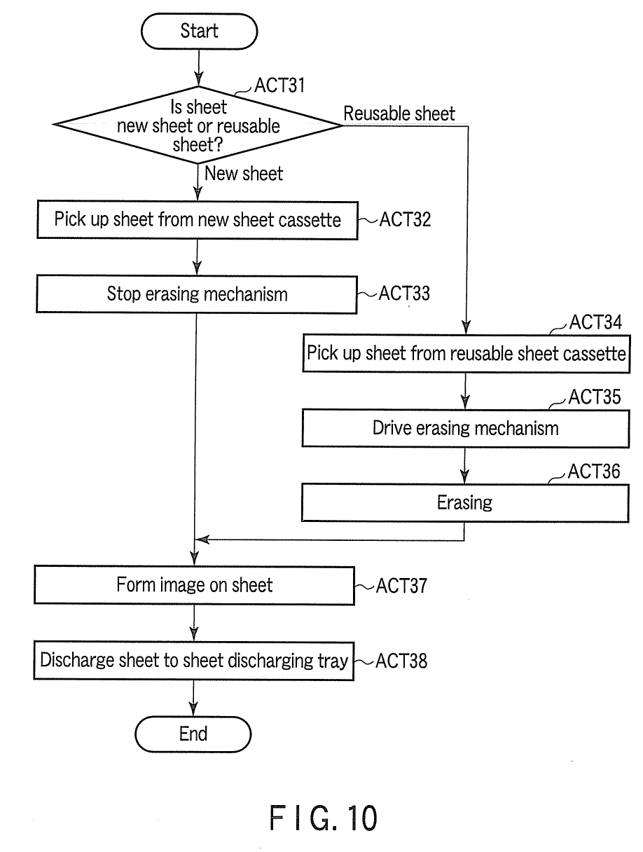

FIG. 10 is a flowchart explaining an operation example of the printer 12D. The operations of the printer 12D described below are mainly controlled by a controller (not shown).

When the user selects the new sheet as the print sheet (ACT 31, new sheet), the pickup roller 102N picks up one of the sheets P′ from the new sheet cassette 10N (ACT 32). In this case, the erasing mechanism 151 does not operate so as not to heat the sheet (ACT 33). In this state, the sheet P′ taken out from the new sheet cassette 10N is transported to the pair of resist rollers 104. Moreover, the new sheet taken out from the new sheet cassette 10N may not be passed through the erasing mechanism 151, but may be transported to the pair of resist rollers 104 through a transport passage.

Alternatively, when the user selects the reusable sheet as the print sheet (ACT 31, reuse), the pickup roller 102R picks up one of the sheets P from the reusable sheet cassette 10R (ACT 34). In this case, the erasing mechanism 151 becomes a driving state, since the erasing mechanism 151 heats the sheet P with the temperature equal to or higher than the predetermined erasing temperature (ACT 35). In this state, the sheet P taken out from the reusable sheet cassette 10R is passed through the erasing mechanism 151. The erasing mechanism 151 erases the image on the sheet P by heating the passing sheet P with the temperature equal to or higher than the predetermined erasing temperature (ACT 36). The sheet P of which the image is erased by the erasing mechanism 151 is transported to the pair of resist rollers 104.

When the sheet P reaches the pair of resist rollers 104, the pair of resist rollers 104 transports the sheet P′ or the sheet P subjected to the erasing to the transport belt 107 at predetermined timing. A desired image is formed on the sheet P′ or the sheet P supplied to the transport belt 107 (ACT 37). At this time, not only the image but also the mark as the information indicating the reusable sheet are printed on the reusable sheet P or the new sheet P′. The reusable sheet P or the new sheet P′ on which the image and the mark are printed is discharged to the sheet discharging tray 14 (ACT 38).

As the result of the printing described above, the image on the sheet taken out from the reusable sheet cassette is erased, and then an image is again printed on the sheet with color erasable ink.

Next, the reuse processing unit 18B of the image forming apparatus 1D will be described.

The erasing mechanism 151 is not provided in the reuse processing unit 18B of the image forming apparatus 1D. Accordingly, the reuse processing unit 18B executes the process of the reuse processing unit 18 of the image forming apparatus 1A, 1B, or 1C except for the erasing of an image.

That is, in the reuse processing unit 18B, the pickup roller 121 picks up each one of the sheets stacked in the sheet feeding tray 16. The pair of transport rollers 122 transports the sheet picked up by the pickup roller 121. The detecting sensor 123 determines whether the sheet transported by the pair of transport rollers 122 is reusable.

When the detecting sensor 123 determines that the sheet is not reusable, the transport passage switching mechanism 124 switches the transport passage, as indicated by an arrow in FIG. 9. In this case, the sheet is cumulated in the cumulative unit 11. Alternatively, when the detecting sensor 123 determines the sheet is reusable, the transport passage switching mechanism 124 switches the transport passage, as indicated by an arrow in FIG. 8. In this case, the sheet is received in the reusable sheet cassette 10R. The erasing mechanism erasing an image on a sheet is not provided in the reuse processing unit 18B. Accordingly, the reuse processing unit 18B does not erase the image on the reusable sheet and receives the reusable sheet in the reusable sheet cassette 10R.

Next, operations of the reuse processing unit 18B having the above-described configuration will be described.

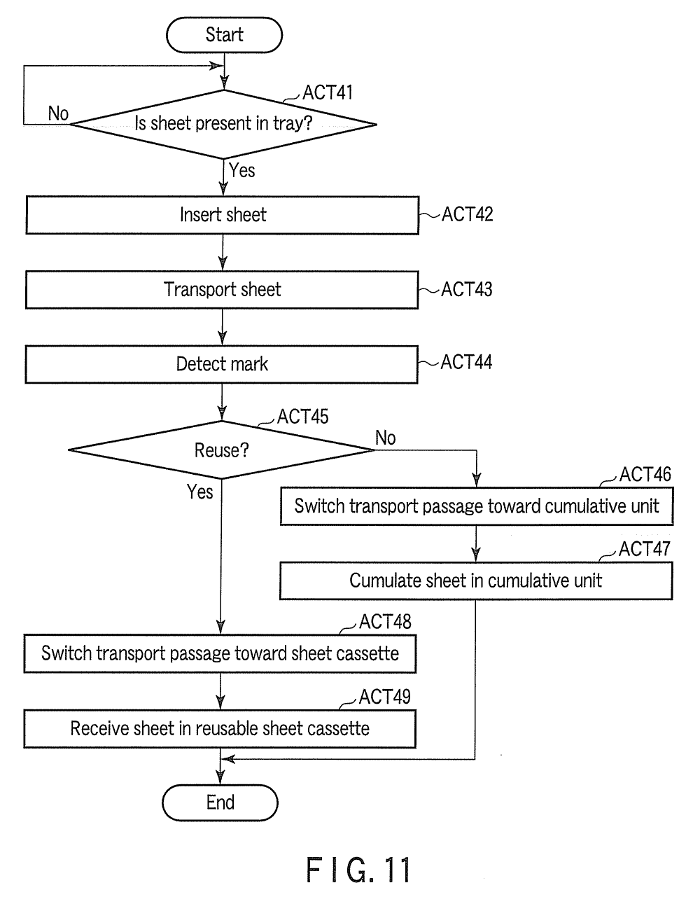

FIG. 11 is a flowchart explaining an operation example of the reuse processing unit 18B. The operations of the reuse processing unit 18B described below are mainly controlled by the controller (not shown).

When a sensor (not shown) detecting a sheet detects the sheets received in the sheet feeding tray 16 (Yes in ACT 41), the pickup roller 121 picks up each one of the sheets on the sheet feeding tray 16 and inserts the sheet into the reuse processing unit 18B (ACT 42). The pair of transport rollers 122 transports the sheet picked up by the pickup roller 121 to the detecting sensor 123 (ACT 43). The detecting sensor 123 detects information indicating whether the sheet transported by the pair of transport rollers 122 is reusable (ACT 44).

When it is determined that the sheet is not the reusable sheet in accordance with the reuse determination which is based on the detection result of the detecting sensor 123 (No in ACT 45), the transport passage switching mechanism 124 switches the transport passage to transport the sheet to the cumulative unit 11, as shown in FIG. 9 (ACT 46). In this state, the sheet is cumulated in the cumulative unit 11 by the sheet cumulating mechanism 127 (ACT 47).

Alternatively, when it is determined that the sheet is the reusable sheet in accordance with the reuse determination which is based on the detection result of the detecting sensor 123 (Yes in ACT 45), the transport passage switching mechanism 124 switches the transport passage to transport the sheet to the reusable sheet cassette 10R, as shown in FIG. 8 (ACT 48). In this state, the sheet is received in the reusable sheet cassette 10R by a transport roller 128 and the sheet setting mechanism 126 (ACT 49).

As the result of the processing described above, the reusable sheets stacked in the sheet feeding tray are received in the reusable sheet cassette without change (state where the color of the image is not erased) and the sheets which are stacked in the sheet feeding tray and not reusable are cumulated in the cumulative unit.

Next, the reuse determination which is based on the detection result of the detecting sensor 123 will be described.

The reuse processing unit 18 of the image forming apparatus 1A, 1B, or 1C or the reuse processing unit 18B of the image forming apparatus 1D determines whether the sheet is reusable on the basis of the detection result of the detecting sensor 123. That is, the detecting sensor 123 detects whether information indicating a possibility of the reuse of the sheet is present on the sheet. In this embodiment, the detecting sensor 123 is configured to detect a predetermined mark as the information indicating the possibility of the reuse of the sheet.

The detecting sensor 123 may be configured to include a scanner which reads an image of an area containing a location where the mark is printed on the sheet and a detector which detects the predetermined mark from the image read by the scanner. Alternatively, the detecting sensor 123 may be configured to include a scanner and a controller (not shown) may determine whether the mark is present (reuse determination).

In this case, the mark as the information indicating the possibility of the reuse of the sheet can be realized in various forms in accordance with an operation scheme. For example, the mark may be printed together when a printer of the image forming apparatus prints an image. Alternatively, the mark may be assigned in advance to the sheet. Moreover, the mark is not limited to a specific shape or color. A location where the mark is printed is not limited to a specific location, as long as the location does not interfere with a main image.

Here, it is assumed that the mark is printed on the reusable sheet under a predetermined condition. For example, on the reusable sheet, the mark having an “R” shape is printed with yellow ink (or toner) at a location of 5 mm from a front end of the sheet and 10 mm from a right end of the sheet. In this case, the mark is detected by scanning the area of 5 mm from the front end of the sheet and 10 mm from the right end of the sheet and determining whether the mark having the yellow “R” shape is present from a scanned image. It is rare that the mark satisfying the above-mentioned condition is not intended and is printed by a known printer. Accordingly, the method of distinguishing the reusable sheets from the non-reusable sheets by determining whether to detect the above-mentioned mark can be realized.

The mark indicating the possibility of the reuse of the sheet is not limited to a specific color or shape. For example, it is possible to realize a method of printing the mark having a predetermined shape with Bk ink (or toner) having a high visibility so that it is easy for a user to determine the possibility of the reuse. Alternatively, a method of printing a mark which a user cannot view may be taken into consideration. In addition, a method of printing a mark on a sheet with special ink or toner which is not used in a general printer may be taken into consideration.

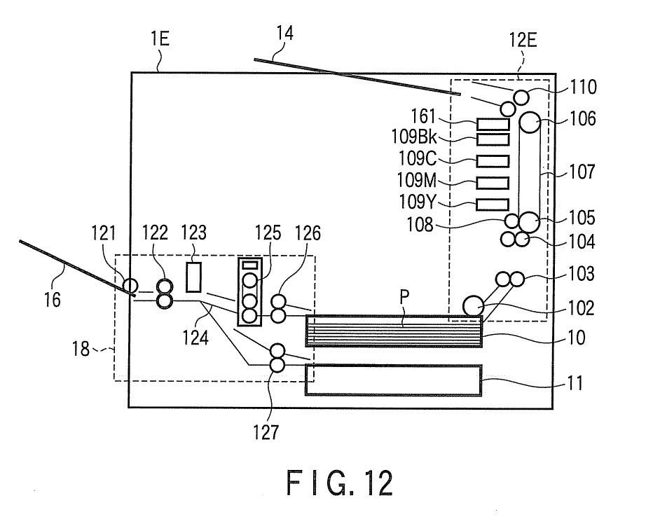

FIG. 12 is a diagram illustrating a configuration example of an image forming apparatus 1E capable of printing the mark with special ink. The image forming apparatus 1E having the configuration example shown in FIG. 12 includes a recording head 161 as well as four-color ink heads. The recording head 161 records the mark with the special ink which is not used in the printing of an image. In this case, the detecting sensor 123 is configured as a sensor which detects the special ink used by the recording head 161.

For example, the recording head 161 prints the mark with the specific ink capable of being detected by ultraviolet light on a sheet. In this case, the detecting sensor 123 is configured as a sensor which detects the mark printed by the recording head 161 by radiating ultraviolet light onto the sheet.

Moreover, the recording head 161 may be a unit which prints the mark with magnetic ink containing particles having a magnetic property. In this case, the detecting sensor 123 is configured as a magnetic sensor which detects the magnetism contained in the magnetic ink forming the mark on the sheet.

Moreover, the shape of the mark is not limited to the “R” shape, but may be printed as various shapes such as a triangle, a square, a diamond shape, a pentagon, a hexagon, a star shape, or a ring shape. Moreover, the location of the mark is not limited to the front end of the sheet, but may be in the rear end, the right end, and the left end of the sheet other than the location of the main image. That is, the mark indicating the reusability may be appropriately set in accordance with an operation scheme.

According to the mode of the printing, an area other than the main image is very narrow (or not present) in the front end, the rear end, the right end, and the left end of the sheet in some cases. In this case, it is difficult to print the mark which can be viewed by a user without the interference with the main image. In this case, the mark indicating the possibility of the reuse of the sheet may be printed so that the mark cannot be viewed by a human. For example, a method of printing the mark indicating the possibility of the reuse of the sheet with ink invisible to a human may be taken into consideration. Moreover, the mark indicating the possibility of the reuse of the sheet may be contained as information in the main image printed on the sheet by an electronic water marking technique or the like. In this case, it is necessary for the detecting sensor 123 to detect the mark which is invisible to a human.

Next, an erasing mechanism as an image erasing apparatus which erases a color of an image on a sheet will be described. Here, the erasing mechanism described below has a configuration which is applicable to the erasing mechanism 125 or the erasing mechanism 151 in the reuse processing unit 18, for example.

Here, the erasing mechanism is configured to erase the color of the image by applying heat to the sheet. In this case, the erasing mechanism may be configured with a thermal head, a thermal bar, or a heat roller. When the heat roller is used, it takes time to increase the temperature of the heat roller up to a temperature at which the erasing is possible. For example, when the heat roller is not heated in advance, the sheets which are received in a tray and to be reused cannot be immediately subjected to the erasing. For that reason, there is a possibility that the sheets which need to be erased are stacked in the tray. In the erasing mechanism using the thermal head or the thermal bar, time required to increase the temperature thereof is short. However, in a structure in which the thermal head or the thermal bar is brought into contact to the surface of a sheet, an erasing performance may considerably deteriorate, since the image forming material such as ink or toner is readily attached on the surface of the thermal head or the thermal bar.

As the erasing mechanism of the image forming apparatuses 1A, 1B, 1C, and 1D described above, an erasing mechanism 210 or 220 having a configuration described below may be used.

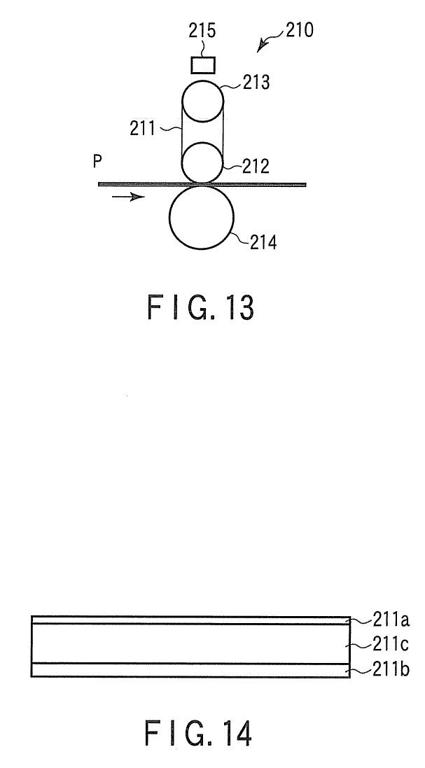

FIG. 13 is a diagram illustrating a first configuration example of the erasing mechanism 210.

The erasing mechanism 210 shown in FIG. 13 includes a belt 211, a support roller 212, a support roller 213, an IH heater 215, and a counter roller 214.

The belt 211 is suspended on the support rollers 212 and 213. The belt 211 is driven with the rotation of the support rollers 212 and 213. The counter roller 214 is opposed to the support roller 212 with the belt 211 interposed therebetween. The sheet P is passed between the counter roller 214 and the belt 211 supported by the support roller 212.

The IH heater 215 heats the surface of the belt 211. The IH heater 215 supplies heat to the sheet through the belt 211. That is, the IH heater 215 may be provided so as to supply heat of the temperature equal to or higher than the predetermined erasing temperature to the sheet through the belt 211. For example, the IH heater 215 is disposed opposite the support roller 213 with the belt 211 interposed therebetween in the example shown in FIG. 13.

With the above-described configuration, the erasing mechanism 210 applies the heat of the temperature equal to or higher than the predetermined erasing temperature to the sheet (the toner or ink on the surface of the sheet) which is passed between the counter roller 214 and the belt 211. Colors of the ink or toner as the image forming material which form an image are erased on the sheet to which the heat of the temperature equal to or higher than the predetermined erasing temperature applied to the erasing mechanism 210 is delivered.

Next, the configuration of the belt 211 used for the erasing mechanism 210 will be described.

In the erasing mechanism 210 having the above-described configuration, the belt 211 has a function of applying the heat supplied from the IH heater 215 to the sheet. Accordingly, the belt 211 needs to have a function of holding the heat supplied from the IH heater 215 until the heat is applied to the sheet and a function of efficiently applying the held heat to the sheet.

FIG. 14 is a diagram illustrating a configuration example of the belt 211. In the example shown in FIG. 14, the belt 211 has a three-layered structure. As shown in FIG. 14, the belt 211 includes a base layer 211a, a surface layer 211b, and an intermediate layer 211c. The base layer 211a is configured as an endless belt of which a base material is polyimide or the like. The thickness of the base layer 211a is 75 μm, for example.

The surface layer 211b is a layer which is directly brought into contact with the surface of the sheet. It is preferable that the surface layer 211b has a configuration in which the toner or ink as the image forming material to be heated is not attached. For example, when the image forming material is attached to the surface layer 211b, there is a possibility that the erasing performance deteriorate. In addition, when the image forming material attached onto the surface layer 211b is re-attached to the sheet, there is a possibility that the re-attached image forming material becomes a noise image on the sheet. For that reason, the surface layer 211b is formed of a Teflon base material, a silicon base material, or the like having a good detachable property. The erasing mechanism 210 may include a cleaning mechanism (not shown) which cleans the surface layer 211b of the belt 211.

The intermediate layer 211c is used to obtain an insulation effect between the base layer 211a and the surface layer 211b. Accordingly, the intermediate layer 211c has a thermal conductivity lower than that of the surface layer 211b. In the erasing mechanism 210 having the configuration shown in FIG. 13, a location where the IH heater 215 as a heating source heats the belt 211 and a location where the belt 211 heats the sheet P are different from each other. Accordingly, the intermediate 211c holds the heat supplied from the IH heater 215 to the location where the sheet P is heated.

The erasing mechanism 210 described above has a configuration in which inconvenience caused due to the attachment of the image forming material such as toner or ink rarely occurs. In the erasing mechanism 210, standby time necessary to be increased up to the erasing temperature is not required. In this way, the erasing mechanism 210 is capable of realizing good erasing. The erasing mechanism 210 is a mechanism which heats the belt 211 using the IH heater 215 as the heating source. This erasing mechanism 210 is capable of repeating the good erasing with lower consumption power and without damage to the erasing performance which is caused due to smear of the image forming material (toner or ink).

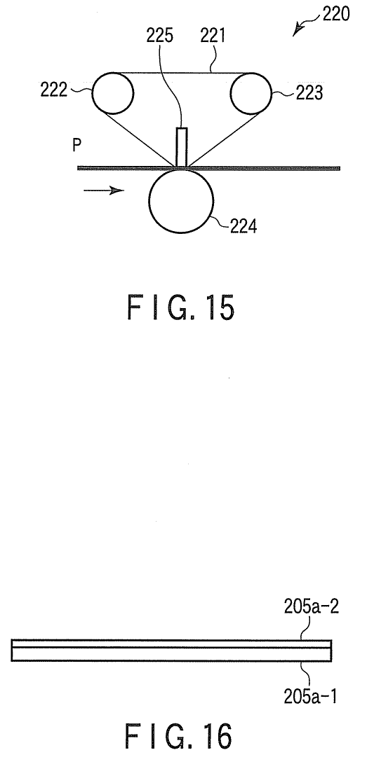

FIG. 15 is a diagram illustrating a second configuration example of the erasing mechanism 220.

The erasing mechanism 220 shown in FIG. 15 includes a belt 221, a support roller 222, a support roller 223, a counter roller 224, and a heating head 225.

The belt 221 is suspended on the support roller 222, the support roller 223, and the heating head 225. The belt 221 is driven with the rotation of the support rollers 222 and 223. The counter roller 224 is opposed to the heating head 225 as a heating source with the belt 221 interposed therebetween. The heating head 225 presses the belt 221 against the counter roller 224.

The sheet P is passed between the counter roller 224 and the belt 211 supported by the heating head 225. The heating head 225 is formed of a thermal head or a thermal bar. The heating head 225 supplies heat of a temperature equal to or higher than the erasing temperature of the image forming material to the sheet P through the belt 221. That is, the heating head 225 heats the sheet P while pressing the belt 221 against the sheet P.

Next, the configuration of the belt 221 used for the erasing mechanism 220 will be described.

FIG. 16 is a diagram illustrating a configuration example of the belt 221. In the example shown in FIG. 16, the belt 221 has a two-layered structure.

The belt 221 shown in FIG. 16 includes a base layer 221a and a surface layer 221b. In the erasing mechanism 220 having the above described configuration, the belt 221 does not need to hold heat. Accordingly, the belt 221 does not have the intermediate layer of the belt 211 described above. It is preferable that the belt 221 possibly delivers the heat supplied from the heating head 225 to the sheet P without heat loss. Accordingly, it is preferable that the thickness of the belt 221 is as thin as possible. However, when the thickness of the belt 221 is too thin, the strength of the belt may be weak. When the strength is weak, a life span of the erasing mechanism 220 (the belt 221) may be shortened. For that reason, it is preferable that the belt 221 is configured to efficiently conduct the heat while maintaining the strength in which a predetermined life span is obtained.

The base layer 221a is formed of a polyimide base material, a metal material (Ni, SuS, etc.), or the like. The thickness of the base layer 221a is in the range of 20 to 150 μm, for example. The life span of the belt 221 is also associated with the Young's modulus of a material of the base layer 221a. In consideration of this point, the base layer 221a is formed of a polyimide base belt or a metal belt (Ni, SuS, etc.) having a high Young's modulus.

The surface layer 221b is a layer which is directly brought into contact with the surface of the sheet. It is preferable that the surface layer 221b has a configuration in which toner or ink as the image forming material to be heated is not attached. For example, when the image forming material is attached to the surface layer 221b, there is a possibility that the erasing performance deteriorates. In addition, when the image forming material attached onto the surface layer 221b is re-attached to the sheet, there is a possibility that the re-attached image forming material becomes a noise image on the sheet. For that reason, the surface layer 221b is formed of a teflon base material, a silicon base material, or the like having a good detachable property. The erasing mechanism 220 may include a cleaning mechanism (not shown) which cleans the surface layer 221b of the belt 221.

As described above, the erasing mechanism 220 directly applies the heat to the sheet P while protecting the surface of the sheet with the belt. In the erasing mechanism 220 having this configuration, standby time necessary to be increased up to the erasing temperature is not required. In addition, in the erasing mechanism 220, inconvenience caused due to the attachment of the image forming material rarely occurs.

Accordingly, the erasing mechanism 220 is capable of realizing good erasing. That is, the erasing mechanism 220 is a mechanism which heats the belt using the thermal bar or the thermal head from the rear surface of the belt. This erasing mechanism 220 is capable of repeating the good erasing with lower consumption power and without damage to the erasing performance which is caused due to smear of the image forming material (toner or ink).

The erasing mechanisms 210 and 220 having the configurations shown in FIGS. 13 and 15, respectively, are similar with the fixing unit used for the electrophotographic type printer. However, in the fixing unit of the electrophotographic type printer, it is necessary to control in accordance with the kind of sheets to be supplied or the number of sheets to be continuously supplied so that the temperature of the fixing member reaches a predetermined temperature range without variation in the temperature of the fixing member. For example, when the fixing temperature is lower than the predetermined temperature range, low temperature offset occurs due to the lack of the fixing. Alternatively, when the fixing temperature is higher than the predetermined temperature range, high temperature offset occurs due to excessively melted toner. For example, when sheets having a small size are continuously supplied, the temperature of both end portions in which the sheets do not pass increases. When this phenomenon is not appropriately controlled, the high temperature offset occurs. That is, in the fixing unit, various measures are necessary in order to strictly control the temperature.

In the erasing mechanisms 210 and 220 shown in FIGS. 13 and 15, respectively, the sheets may be heated with the temperature equal to or higher than the erasing temperature within a range in which damage to the sheets is not caused. In the erasing mechanisms 210 and 220, the strict temperature control is not necessary. Accordingly, the erasing mechanisms 210 and 220 having the configurations shown in FIGS. 13 and 15, respectively, can be realized using a simple temperature control mechanism and easily realized at low cost.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus comprising:
a tray in which sheets are stacked;
a detecting sensor which detects whether a mark indicating a reusable sheet is assigned to the sheets in the tray;
a cumulative unit which cumulates the sheets of which the mark is not detected by the detecting sensor;
a color erasing unit which erases a color of an image forming material attached onto the sheets of which the mark is detected by the detecting sensor;
a sheet cassette which receives the sheets of which the image forming material is erased by the color erasing unit; and
an image forming unit which forms an image by attaching the image forming material onto the sheets received in the sheet cassette.

2. The apparatus according to claim 1, wherein the image forming unit prints the mark indicating the reusable sheet together with the image.

3. The apparatus according to claim 1, wherein the image forming unit forms an image on the sheets with ink as the image forming material erasable by the color erasing unit.

4. The apparatus according to claim 1, wherein the image forming unit forms an image on the sheets with toner as the image forming material erasable by the color erasing unit.

5. The apparatus according to claim 1, further comprising:
a second cassette in which sheets are received by a user,
wherein the image forming unit forms an image on the sheets received in one of the sheet cassette or the second cassette with the image forming material erasable by the color erasing unit.

6. The apparatus according to claim 1, further comprising a mark recording unit which records the mark indicating the reusable sheet on a sheet on which an image is formed by the image forming unit with the image forming material erasable by the color erasing unit.

7. The apparatus according to claim 6, wherein the mark recording unit records the mark indicating the reusable sheet with special ink.

8. An image forming apparatus comprising:
a tray in which sheets are stacked;
a detecting sensor which detects whether a mark indicating a reusable sheet is assigned to the sheets in the tray;
a cumulative unit which cumulates the sheets of which the mark is not detected by the detecting sensor;
a sheet cassette which receives the sheets of which the mark is detected by the detecting sensor;
a color erasing unit which erases a color of an erasable image forming material attached onto the sheets taken out from the sheet cassette; and
an image forming unit which forms an image by attaching the image forming material onto the sheets of which the image forming material is erased by the color erasing unit.

9. The apparatus according to claim 8, wherein the image forming unit prints the mark indicating the reusable sheet together with the image.

10. The apparatus according to claim 8, wherein the image forming unit forms an image on the sheets with ink as the image forming material erasable by the color erasing unit.

11. The apparatus according to claim 8, wherein the image forming unit forms an image on the sheets with toner as the image forming material erasable by the color erasing unit.

12. The apparatus according to claim 8, further comprising:
a second cassette in which sheets are received by a user,
wherein the color erasing unit does not erase the color of the image forming material and supplies the sheet to the image forming unit, when an image is formed on the sheets received in the second cassette.

13. The apparatus according to claim 8, further comprising a mark recording unit which records the mark indicating the reusable sheet on a sheet on which an image is formed by the image forming unit with the image forming material erasable by the color erasing unit.

14. The apparatus according to claim 13, wherein the mark recording unit records the mark indicating the reusable sheet with special ink.

15. An image erasing apparatus comprising:
a heat source which heats a sheet on which an image is formed with an image forming material erasable by heating;
a belt which applies heat supplied from the heat source to the sheet being brought into contact with the belt while being transported; and
a sheet cassette which receives the sheet to which the heat supplied from the heat source is applied through the belt.

16. The apparatus according to claim 15, wherein the heat source is an induction heating type heater.

17. The apparatus according to claim 15,
wherein in the belt, a location where the heat is supplied from the heat source and a location where the belt is brought into contact with the sheet are different from each other, and
wherein the belt is driven while maintaining the heat supplied from the heat source and applies the heat maintained to the sheet at the location where the belt is brought into contact with the sheet.

18. The apparatus according to claim 17, wherein the belt includes a base layer, a surface layer, and an intermediate layer.

19. The apparatus according to claim 15, wherein the heat source is one of a thermal head and a thermal bar.

20. The apparatus according to claim 15,
wherein in the belt, a location where the heat is supplied from the heat source and a location where the belt is brought into contact with the sheet are the same, and
wherein the belt delivers the heat supplied from the heat source to the sheet.

21. The apparatus according to claim 20, wherein the belt includes a base layer and a surface layer.

22. A sheet processing method used in an image forming apparatus, comprising:
detecting whether a mark indicating a reusable sheet is assigned to a sheet;
cumulating the sheet of which the mark is not detected in a cumulative unit;
erasing an image forming material attached to the sheet of which the mark is detected;
receiving the sheet of which the image forming material is erased in a sheet cassette; and
forming an image by attaching the image forming material to the sheet received in the sheet cassette.

23. The method according to claim 22, wherein the forming prints the mark indicating the reusable sheet together with the image.

24. The method according to claim 22, wherein the forming forms an image on the sheets with ink as the image forming material erasable by the color erasing unit.

25. The method according to claim 22, wherein the forming forms an image on the sheets with toner as the image forming material erasable by the color erasing unit.

26. The method according to claim 22, wherein the erasing is accomplished by an induction heating type heater.

27. An image forming apparatus comprising:
a first sheet holding section holding a sheet;
a first sheet transporting section which transports the sheet held by the first sheet holding section;
a detecting sensor which detects whether the sheet transported by the first sheet transporting section has a mark indicating a reusable sheet;
a second sheet transporting section which transports the sheet detected as the reusable sheet by the detecting sensor;
a image erasing unit which erases an image on the sheet transported by the second sheet transporting section; and
a second sheet holding section which holds the sheet which the image is erased by the image erasing unit.

28. The apparatus according to claim 27, further comprising:
an image forming unit which prints the mark indicating the reusable sheet together with the image.

29. The apparatus according to claim 27, further comprising:
an image forming unit which forms an image on the sheets with ink as the image forming material erasable by the color erasing unit.

30. The apparatus according to claim 27, further comprising:
an image forming unit which forms an image on the sheets with toner as the image forming material erasable by the color erasing unit.

31. The apparatus according to claim 27, wherein the image erasing unit comprising a heat source which is an induction heating type heater.

32. An image forming method comprising:
transporting a sheet held by a first sheet holding section;
detecting whether the sheet has a mark indicating a reusable sheet while transported;
erasing an image on the sheet detected as a reusable sheet; and
holding the sheet which the image is erased.

33. The method according to claim 32, further comprising:
printing the mark indicating the reusable sheet together with the image.

34. The method according to claim 32, further comprising:
forming an image on the sheets with ink as the image forming material erasable by the color erasing unit.

35. The method according to claim 32, further comprising:
forming an image on the sheets with toner as the image forming material erasable by the color erasing unit.

36. The method according to claim 32, wherein the erasing step is accomplished by an induction heating type heater.
